(19) United States
(12) Patent Application Publication
(10) Pub. No.: US 2005/0243992 A1
(43) Pub. Date: Nov. 3, 2005

(54) Telecommunications facility, group of telecommunication facilities, method of configuring and operating such group and software for identifying a client and a facility therein

(75) Inventors: Heinz-Mathias Braun, Dormagen (DE); Udo Kayser, Wuppertal (DE); Frank Rodewald, Bedburg (DE)

Correspondence Address: THE FIRM OF KARL F ROSS, 5676 RIVERDALE AVENUE, PO BOX 900, RIVERDALE (BRONX), NY, 10471-0900, US

(73) Assignee: TENOVIS GmbH & Co. KG

(21) Appl. No.: 11/084,850

(22) Filed: Mar. 17, 2005

(30) Foreign Application Priority Data
Mar. 17, 2004 (DE) 102004013330.1

(51) Int. Cl. H04M 7/00; H04M 3/00; H04M 5/00

(52) U.S. Cl. 379/242

(57) ABSTRACT

A telecommunication group is formed by a multiplicity of private telecommunication facilities configured to connect calls between clients services by those facilities and subscribers of those clients based upon facility identification numbers AID and client identification numbers KID determined by dispatcher numbers from E.164 call numbers.

### FIELD OF THE INVENTION

Our present invention relates to a telecommunications facility, a group of telecommunications facilities, a method of configuring that group or at least one telecommunication facility of such a group, a method of configuring that group or at least one telecommunication facility of such a group, a method of operating a group of telecommunications facilities, and to a software for identifying a client and a facility in such a group whereby a multiplicity of clients can each have a multiplicity of terminal devices which can communicate over that group independently from one another, i.e. can utilize the group independently.

### BACKGROUND OF THE INVENTION

Telecommunication facilities are available to serve subscribers and terminal devices with various performance features utilizing telephone numbers and, by and large have been highly successfully to date. Large private telecommunication facilities may involve in excess of 10,000 subscribers. When such telecommunication facilities are networked, for example by QSIG, the resulting communication system may handle a number of subscribers which is limited only by the maximum permissible length of the call numbers which are used. Telecommunications facilities of such size not only require a broader spectrum, but also can have performance features which cannot be provided by smaller telecommunications systems and can, for example, be utilized for server-based applications of, for instance CTI (Computer Telephony Integration) and CRM (Customer Relations Management) and with Call Center features.

The performance features of telephone systems can be implemented at different costs. For example, complex communications-related features and server-based applications involve high capital cost which often cannot be borne by systems with fewer subscribers, because they may not be economical. Many features, therefore, are not to be found in smaller telephone systems or can be found there only seldom. There are features which can serve systems with many clients each with respective subscriber groups in a central manner to thereby reduce the cost of any feature per subscriber to an economical level. However such features generally have to be provided on a system-wise basis. Two systems of this type are the Centrex Service, for example of the public network of Deutschen Telekom AG and the so-called “Multi-Company” service used in the field of private telecommunications.

With Centrex service the typical performance features of private networks are centrally supplied through the public network for a number of clients. The network intelligence, that is the control of the performance features can be found in the public network and the interface between the public network and the private network can be a virtual location with the function of a gateway within the public network. In the multicompany approach, utilizing private networks, the communication system of a building or some other unit is operated through a network driver like that of AVA-YA-TENOUIS or Regus Corporation of the United Kingdom. The network intelligence is located in the private network on campus and the transition between the private network and the public network is also on campus. The private network can include a plurality of private telephone facilities. A plurality of legally independent clients or customers can be served by a telephone facility. An administrator of the network drive which serves the telephone facility can implement the performance features selected by the customer and prepares the subscribers of the customer for them. The private telephone facility in accordance with the prior art, normally is not conceived for such use of the performance features and therefore it may not be possible to provide all possible combinations of performance features for the individual customers, singly or simultaneously.

For that reason the operator may provide packages of the performance features for simultaneous use by all subscribers of a given customer. In one system the number of firms which can be handled is limited to 64 and the telephone system cannot recognize the firm or the customer or the client. As a result the application of performance features is limited or must be matched to particular conditions and may not allow, for example, the formation of traffic groups of subscribers. When reference is made herein to the “client” and “customer”, it will be understood that these terms may be used interchangeably to mean the same entity. Either may have one or more enterprises and each such enterprise of the latter will generally have one or more, usually a multiplicity of subscribers, each of which may have a terminal device. Thus the term “subscriber” and “terminal device” may be used interchangeably as well. From the perspective of a telecommunication facility, a subscriber line usually has the singular identification which can also apply to the corresponding terminal device. With the aid of a call number plan, the relationship between the subscriber line of a terminal device and the internal call number of the subscriber can be made.

It is also known to operate telecommunication facilities in a group such that the respective facilities of the group are interconnected by digital tie lines between the individual facilities. The communications protocol used for these tie lines can either be a standardized protocol (QSIG, DPNSS1) or a proprietary protocol (TNET, CORNET . . . ). The telecommunication facilities in a group have devices for charging the use of the line per connection and the connection duration. In accordance with the state of the art, a group of private telecommunication facilities can be provided, not all of which service respective single clients.

Conventional systems with client-based operations in the realm of private telecommunication facilities have been limited in the sense that the customers are limited to individual facilities. While such facilities can be operated in a group setting, the group-wide functioning does not apply to multiclient operations. For example, subscribers of the same client may not be recognized as belonging the particular client when the terminal device is connected to a variety of telecommunication facilities of the group. This is especially disadvantageous because connections between terminal devices of the same client may be handled differently from those between terminal devices of different clients. The connection between terminal devices of different clients may thus be conceived of like communications going through a public exchange. Since many firms have enterprises or units which are widely geographically distributed, in addition to their central office, and many of these locations may have terminal devices in large number which should be integrated with the home office, treatment of multiple subscribers of a single client differently from one another and those of subscribers of different clients from different telecommunication facilities of a group differently from one another has limited the versatility of earlier systems.

### OBJECTS OF THE INVENTION

It is, therefore, the principal object of the present invention to provide a communication system in the form of a group of telecommunication facilities, each of which can service a multiplicity of clients and each client of which can have a multiplicity of subscribers and terminal devices, whereby the aforementioned drawbacks are avoided.

Another object of the invention is to provide a telecommunication facility with a multiplicity of clients and a multiplicity of subscribers and wherein that telecommunication facility can be part of a group of such facilities connected by tie lines with greater facility than has hitherto been the case.

Still another object of this invention is to provide an improved method of configuring a group of telecommunication facilities or a telecommunication facility of such a group for improved utilization of performance features by the client and subscribers of that group.

A further object is to provide an improved method of operating a group of interconnected telecommunication facilities and telecommunication facilities connectable in a group whereby disadvantages of earlier systems are avoided.

### SUMMARY OF THE INVENTION

These objects and others which will become apparent hereinafter are attained, in accordance with the invention in a telecommunications facility for forming a group with at least one other the telecommunications facility and comprising a memory for storing data as to subscribers of clients of the at least one other telecommunications facility capable of utilizing the group of telecommunications facilities together and independently from one another, the data including evaluation-relevant parts of call numbers of each subscriber of the at least one other telecommunications facility capable of utilizing the group of telecommunications facilities together and independently from one another, a facility identification number AID of the at least one other telecommunications facility to which the respective subscriber with the respective call number is connected, and a client identification number KID of the client of the respective subscriber.

That telecommunication facility or each telecommunication facility further comprises a dispatcher unit for determining a KID and an AID or for determining an AID from a call number of an incoming call.

The group is thus formed of at least two such telecommunication facilities interconnected for call transfer between them and to subscribers and clients of the respective facilities.

At least one of these facilities has a client-to-client routing table which, for each client identification number KID permits internal traffic within the group for subscribers assigned to the corresponding client.

The invention is also a method of configuring a group of interconnected telecommunications facilities each having a plurality of clients each with a respective plurality of terminal devices capable of communicating through the group independently of one another, the method comprising the steps, in at least one of said telecommunications facilities, of:
assigning a respective facility identification number AID to each of the facilities in the group;
assigning a client identification number KID to each client in the group;
storing evaluation-relevant parts of E.164 call numbers of subscribers of one of the facilities and subscribers of other facilities which are required for determination of the AID and KID thereof as dispatcher numbers; and
assigning the AID and KID to the dispatcher numbers.

The method can further comprise the step of of creating a client-to-client routing table which, for each client identification number KID permits internal traffic within the group for subscribers assigned to the corresponding client.

In each of the facilities the AID can be used to assign that facility to tie lines over which he respective facility can be reached. A transmission capacity over a tie line from one facility to another facility of the group can be reserved for a client, based upon the client identification number KID thereof. The method of operating the group of telecommunications facilities can comprise the steps of:
receiving a call;
determining a client identification number KID singularly assigned to each client from a call number of the call; and
assigning the call to the client identified by the determined client identification number KID.

A determination as to whether the call derives for a caller belonging to the same client as the called terminal device can be made as can a determination as to whether a connection is possible internally of the group between the caller and the called device.

According to the invention a private telecommunication system is provided which comprises a plurality of individual telecommunications facilities forming a group which, in turn, can communicate by trunk lines with the public network. The connection between the telecommunication facility is through digital tie lines and the communication protocol between these facilities and over the tie lines is either the standard QSIG protocol to one of the proprietary protocols (TNET, CORNET . . .

According to the invention a private exchange is formed by the group of telecommunications facilities, each of which can have a plurality of clients and each of those clients a plurality of terminal devices which can utilize the group independently of one another as if only a single client was serviced through this private exchange or group. This is achieved in that the private exchange creates a plurality of virtual telecommunications facilities, each with its own data repository and its own data access structure for each client. Each such virtual facility can be assigned to a respective client or customer and can service its subscribers independently and organizationally separately from the subscribers of other clients. Each client can have available to it a client-individual freely selectable and client-controlled client call number plan.

The communication system as a whole can serve as a private telecommunication system for any optional number of clients, each with any optional number of subscribers or terminal devices. Within the virtual facility, a client can organize all performance features either on a client-wide basis or independently for its subscribers. This can be done largely through a client administrator himself or herself, for example by assignment of subscriber rights in conjunction with traffic to and from a public net or central office traffic or through use of performance features. The selection and alteration of specific data within the virtual facility however remains the province of the system administrator. Such system administrator tasks can include configuration of traffic between virtual facilities of different clients and the blocking and unblocking of hardware addresses. In this private exchange, each client is assigned a client identification number KID. The client-identification number enables the client-individual setup or organization of the virtual telephone facility.

The present invention comprises a network of private telecommunication facilities which together form a group. The invention is independent of the configuration of the particular customer-based private telecommunication facility used. The telecommunication facilities according to the invention form a group in which at least one further telecommunication facility has a memory for storing data by means of which the subscribers of clients connected to the group through that further facility can use the group through that further facility and can use the group in common with the other subscribers because evaluation-relevant parts of call numbers of the subscribers of the further facility are used to yield a facility identification number AID of the further facility and a client identification number KID which identifies the client of the respective subscriber. The evaluation-relevant part of the call number is thus significant for the purposes of the present invention since it enables alone the determination of the AID and KID, singularly from the call number. The evaluation-relevant part of the call number forming the KID does not have to coincide with the evaluation-relevant part of a call number forming the AID.

Call numbers are generally read from the first digit on the left to the last digit on the right without gaps between them. The evaluation relevant part of the call number can be the access call number of a client relevant to the public network since all extension identification numbers also will be associated with this access call number for a particular client. Generally the extension numbers follow the access call number of a client for a given telecommunication facility and, in that case, form a client and extension-identifying part of the E.164 call number which additionally has a facility identification included therein.

With the customer-based telecommunication group of the invention, it is possible to provide clients with fewer subscribers economically with the service afforded larger telecommunication systems because of the facility grouping. The incorporation of a telecommunication facility in such a group can be done at relatively low cost and thus the group can provide service for small firms at a variety of locations. Because a singular relationship is provided between the evaluation-relevant part of the call number and KID, the telecommunication system of the invention can provide for any call determination as to whether the client-internal traffic is possible or not. With a client-to-client routing table which indicates for each KID the appropriate client and the subscribers thereof, the system can provide internal traffic or, where necessary or desirable, a connection to the open network. Internal traffic uses exclusively resources of the group.

### BRIEF DESCRIPTION OF THE DRAWING

The above and other objects, features, and advantages will become more readily apparent from the following description, reference being made to the accompanying drawing in which:

FIG. 1 is a schematic illustration of a private telecommunication facility which can be connected in a network to a group with other such facilities;

FIG. 2 is a schematic illustration of the accessing utilizing appropriate software of the data base of a telecommunication system according to the invention;

FIG. 3 is schematic illustration of a group of private telecommunication facilities according to the invention;

FIG. 4 is an information flow diagram of a method of configuring a group of private facilities;

FIG. 5 is an information flow diagram of a method of operating a group upon receipt of a call from an internal source;

FIG. 6 is an information flow diagram of a method of operating the group upon receipt of a call or an internal source; and

FIG. 7 is an information flow diagram of a method of operating the group of private facilities according to the invention upon receipt of a call on a tie line of the group.

### SPECIFIC DESCRIPTION

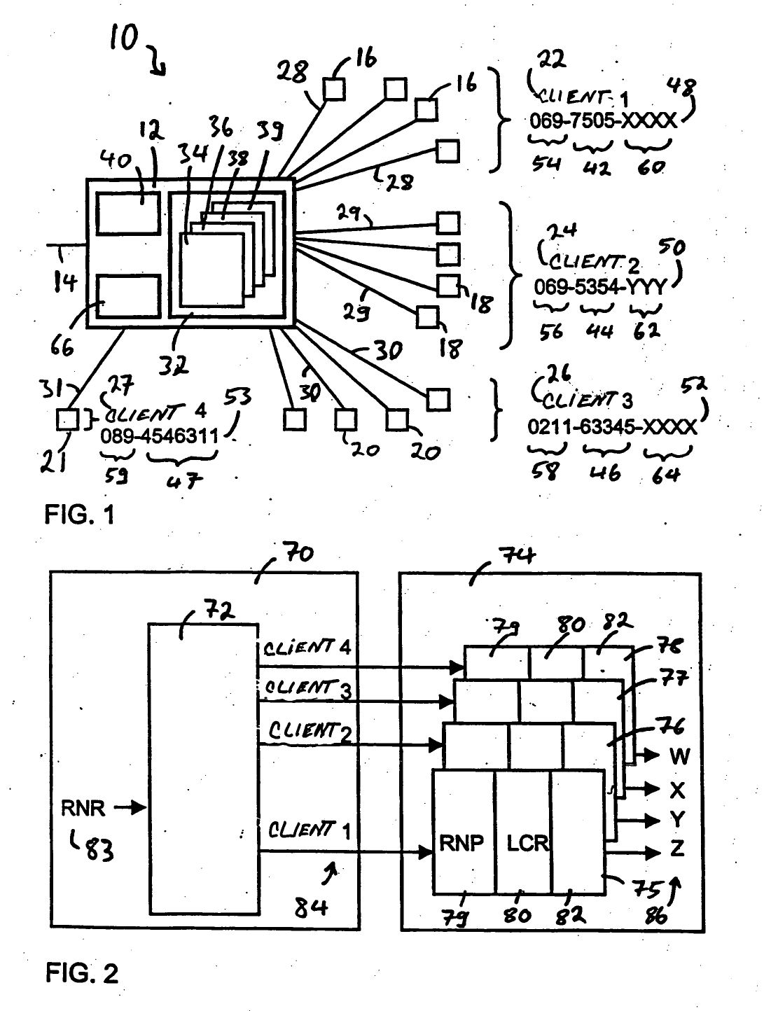

FIG. 1 shows schematically a communication system or facility 10 in accordance with the invention having a central communication apparatus or exchange or “center” represented at 12 and which is connected via a line 14 (representing one or more trunk lines) to an open or public telephone or like network.

To the communication unit or exchange 12, terminal devices 16, 18, 20, 21 or subscribers of different clients 22, 24, 26 and 27 are connected by respective lines 28, 29, 30, 31 also referred to herein as subscriber lines.

The terminal devices 16, 18, 20 and 21 can represent any devices commonly used in a telecommunication system and can be, for example, analog telephones, ISDN telephones, system telephones, IP telephones (IP=internet protocol), telefax devices, answering machines, pagers or the like.

For selecting among the completely independent clients 22, 24, 26, 27 the exchange 12 can be provided with a device 32 which provides for each client a freely selectable calling number plan individual to that client. This device which contains the calling number plans of all of the clients and makes them available to each client can be of a type which has been used in the past with private telephone exchanges and can be equipped with a database or data collection for each of the different clients. Because of the separation of the respective data collections from one another, the device 32 for making the calling number plans available can be considered to contain a corresponding number of virtual private telephone exchanges, units, centrals or equipment 34, 36, 38, 39 for each of the clients 22, 24, 26, 27 respectively.

The terminal devices 16, 18, 20, 21 or subscribers of different clients 22, 24, 26, 27 form respective groups of subscribers of the respective clients, whereby the clients or their groups can utilize the communication system 10 independently of one another with each client being freely selectable and each subscriber of each client also freely selectable through the client directed client call number plan.

In addition, the central communication exchange 12 has a device 40 for adapting a client-individual access call number according to recommendation E.164 of the public network so that the client can be selectable through the public network. The selection is made by transmitting the singular E.164 call number. A worldwide singular call number 48, 50, 52, 53 is comprised, according to E.164, of an access call number of a client with respect to the public network and optionally an internal subscriber number 60, 62, 64. The attribute “internal” means that this part of an E.164 calling number is sufficient to direct communications entirely within the specific telecommunications apparatus or exchange. The access call number with respect to the public network is comprised of the calling number of the client 42, 44, 46, 47 in the respective local network and optionally additional calling numbers 54, 56, 58, 59 for the local network and optionally the country of the client to establishing the singularity with respect to the public network. The client 4 has the special distinction that this client and only operates a single terminal device 21 and thus the call number 53 of the client 4 is identical to the access call number relative to the public network, namely, the parts 59 and 47. In this case, no distinction as to subscribers of the client is necessary with clients having a plurality of subscribers like 22, 24, 26, the subscribers are identified by the subscribers number 60, 62, 64.

On the one hand, a terminal device can be singularly identified with its internal call number within a telephone communication unit or local exchange and on the other hand, upon a subdivision of a local exchange into a multiplicity of virtual telecommunication units or exchanges, the internal call number will generally no longer suffice since any given internal call number can be used by a plurality of clients. As a consequence, in the aforedescribed telecommunication apparatus each terminal device is selected by a call number which corresponds to the E.164 call number plan.

For example, let us assume there is an extension in an enterprise of client A and an enterprise of a client B with the internal call number “4711” of the client. Client A has the access code “5354” in the local net and client B has the access code “7505”. For a telecommunication apparatus in Germany (International country code “49”) and in the city of Frankfurt (local net identifier “69”) the call number which will singularly identify the extension “4711” for client A will bear the number and 496953544711 and the extension for client B the singular call number 496975054711.

As a consequence within a given telecommunication apparatus or exchange, the association of a client with a call number allows the selection of any given subscriber number or extension within the call number plan of the client. A hardware configuration means that the association of the access number with the subscriber is built into the hardware. Each client of a telecommunication apparatus is assigned an integer value which is the client identification number KID.

The device 40 enables each client 22, 24, 26, 27 to use its own call number 42, 44, 46, 47 which is fully independent from the call numbers of the other clients with reference to the open net. These call numbers with respect to the open net are independent from the number and type of trunk lines 14 with which the communication system 10 is connected to the open net. To simplify the illustration, connection to the open net may use only national characterizing digits for the local mode selection in the long distance network of, for example, Deutsche Telecom AG as represented at 54, 56, 58 and 59. The numbers within the number plan intrinsic to the client are individual to the client and can be identical or partly identical blocks of call numbers which can be optionally of different lengths, i.e. have different numbers of digits, within the same physical communication apparatus or unit 12. Thus, for example, the client 24 can have a call number plan using three part or three digit call numbers 62. The clients 22 and 26 can have largely overlapping or identical call number plans each with four digit call numbers 60 and 64. Within the communication apparatus 12, regions containing the client data for different clients are stored and accessed separately through the client identification number KID. Based upon the client identification number, the clients are so distinguished that the client identification number is capable of singularly distinguishing even between party identification client call number plans.

The communication apparatus or local exchange 12 has, in addition, a device 66 for analyzing and allocating call numbers. The device 66 serves for obtaining the client identification number from a call number of an incoming call. The call numbers are of worldwide or equivalent universal significance. With an incoming call from the public network, the call number serves as a target number for the call. The device 66 is effective in addition as a device for determining or enabling a hardware address of the target device from the call number of worldwide significance and from which the client identification number is derived upon a call from an external source. After the device 66 has analyzed the call number and determined the client identification number, it can, via the device 32 which prepares the calling number plans, select the calling number plan associated with the client identification number and determine based upon the subscriber numbers 60, 62, 64 the hardware address of the desired subscriber connection and make the connection of the incoming call to the desired subscriber through the communication facility 12.

The device 66 for analysis and assignment, therefore, operates in the case of a call from an internal source as a device for detecting a client identification number from the hardware address of the called subscriber. When the client identification number of the called subscriber and thus the client to which the subscriber belongs is known, the selected number in accordance with the rules that this subscriber has set, can be analyzed and an internal or external connection made with the caller.

FIG. 2 shows schematically the interaction of the call control software and the data content in a communication system in accordance with the invention. The here described part of the call control software relates to the analysis and assignment of call numbers and the call number plan and thus the effect of the devices 66 and 32 from FIG. 1. The data repository corresponds to the call number plan and the data repository are distinct for the respective clients and thus correspond to virtual telecommunication facilities 34, 36, 38 and 39 as have been shown in FIG. 1.

Within the call control software 70, dispatcher software 72 can drawn upon a database 74. Initially the dispatcher software 72 will be described. The database software 72 serves to assign call numbers or call numbers segments to AID and KID, conversely. In the database 74, data is stored for the clients separately and can be tapped or read out based upon the client identification number. In other words the data is stored based upon the client identification number in the regions 75, 76, 77, 78 contains a corresponding call number plan 79 which can be the information as to a client-individual, least-cost routing (LCR) 80 to the hardware addresses of the subscribers and other client-specific data 82.

The mode of operation of the dispatcher software 72 will be described based upon an incoming call from an external source. The incoming target call number 83 is analyzed by the dispatcher 72 and the client identification number contained therein is determined.

Based upon this client identification number 84, the database 74 is accessed and the particular region 75, 76, 77, 78 of the database 74 to which that client identification number 84 is assigned can be read. With such access, the part of the call number 83 shown in FIG. 1 at 60, 62, 64 referred to as the subscriber segment is determined and from the call number plan 79 of the client identification number 84, the subscriber is determined and the corresponding address of the subscriber connecting line is obtained and forwarded as the hardware address 86. In the case of the client 4 in FIG. 1 with only one terminal device 21, the single subscriber is singularly identified by the client identification number and thus only the associated address of the subscriber line 80 is determined and outputted as the hardware address 86. Another part of the enabling software 70, i.e. the call control software, can follow the connection until the interconnected partners terminate the call. Upon a call from an internal source, the dispatcher 72, with the aid of the database determines the client identification number from the line address of the called subscriber and thus the client and analyzes the selected call number and determines whether it involves an internal or external call. Based upon the data content, the call control software can recognize calls to other clients and external calls. Another part of the call control software 70 can thus decide whether the analyzed call number data requires a connection to another subscriber of the same client or externally.

In a group of telecommunication facilities, the group may interconnect telecommunication facilities which are as a rule geographically distributed. This distribution can be in part through a local net, through a plurality of local nets or can extend over several countries. Since the worldwide distribution is taken into consideration with E.164 call numbers, such call numbers are effective in telecommunication facilities which have the geographic distribution described, i.e. where a single exchange can service the individual locations of clients distributed worldwide through different telecommunication facilities of a group. If there is no office access, i.e. access to the public exchange, for the terminal device of a client of a telecommunications facility of the group, the office communication, i.e. the communication with the center office of the public exchange, is effected through a telecommunication facility of the group with such access. In this case, all of the terminal devices of a client whose access to the open telecommunications network is effected via this telecommunication facility will have the client access call number of the telecommunication facility with the central office access. An affirmation as to which telecommunication facility of the group has a terminal device connected to it can in this case be indicated only by the additional evaluation of part of the digit sequence or of the entire digit sequence of the internal terminal device number.

According to the invention, a telecommunication facility of a group of such facilities will have a facility identification number AID assigned to it so that each telecommunication facility in the group will have a respective AID. If the location of a client must be reached by an access call number common to all of the client locations, optionally a part of the internal call number must be evaluated to determine the facility identification number AID. The facility identification number has advantageously the structure of an integer value and is stored in the configuration data of the facility repository or memory.

For full description of any single terminal device, therefore, in this case a combination of the client identification number, the facility identification number and the internal call number is provided.

A telecommunication facility according to the invention should thus:
be capable of recognizing all access call numbers of all clients of the group,
additionally recognizing facility identification numbers from the digit sequence of the internal call numbers of the terminal device,
include a device which can determine the client identification number and the facility identification number from a call number, and should be able to convert the worldwide E.164 number
using the client identification number and the facility ID number into a client-referencing internal call number of a specific terminal device.

An extension call number can then be used a number of times with respect to a particular client but will only be significant to a single extension when associated with the telecommunication facility of the group for this client.

The telecommunications facility described with respect to FIGS. 1 and 2 has a database system and a dispatcher with the aid of which, from a call number or the hardware address of the connecting line of a terminal device, a client identification number can be determined. From the protocols which are used to form the group of telecommunication facilities, call numbers for routing (in QSIG and TNET: called party number) and call numbers for the identification (in QSIG and TNET: calling party number, connected number) are known.

According to the invention, moreover, the database system and dispatcher for group tasks are so configured that client identification numbers and facility identification numbers are obtained from evaluation relevant parts of an E.164 call number or the hardware addresses of the connecting lines of the terminal device. The call numbers of subscribers are included even if they belong to other facilities than the facility of the dispatcher. The call number information which is exchanged through the tie lines of the group in a preferred configuration have basically the E.164 format. The dispatcher uses for determination of the client preferably identifying call numbers. When the signals omit identification call numbers, the dispatcher can use routing call numbers to determine the client. The dispatcher relies dispatcher software for identifying a client in a group of telecommunication facilities based upon a client identification number KID associated with each client, whereby the identification is carried out with the aid of dispatcher numbers stored in one of the facilities. These dispatcher numbers include such parts of the E.164 call numbers of a subscriber connected to a further facility which are required for determining the AID and KID. The determination of the AID and KID is effected based upon the call number obtained upon receipt of a call.

Usually, the AID and KID provide a local net selection and the access number of the client belonging to this local net at a certain geographical location of this client. For example, the AID may be significant or singular in the sense that there is a high probability that all subscribers of this client will be connected to the local net at a single telecommunication facility at the single geographic location. In that case, the KID is singularly capable of identifying the local net as well, since other clients may have other local net access numbers in this local net. In this example, the use of dispatcher numbers can require less data storage because the storage of data with respect to extension numbers for other facilities of the group is not necessary.

According to the invention, an expansion of the telecommunication facilities of the group by providing them with a client to client routing table in a matrix structure allows determination as to whether connections between the terminal devices of two different clients can be connected internally or require connection through the public network.

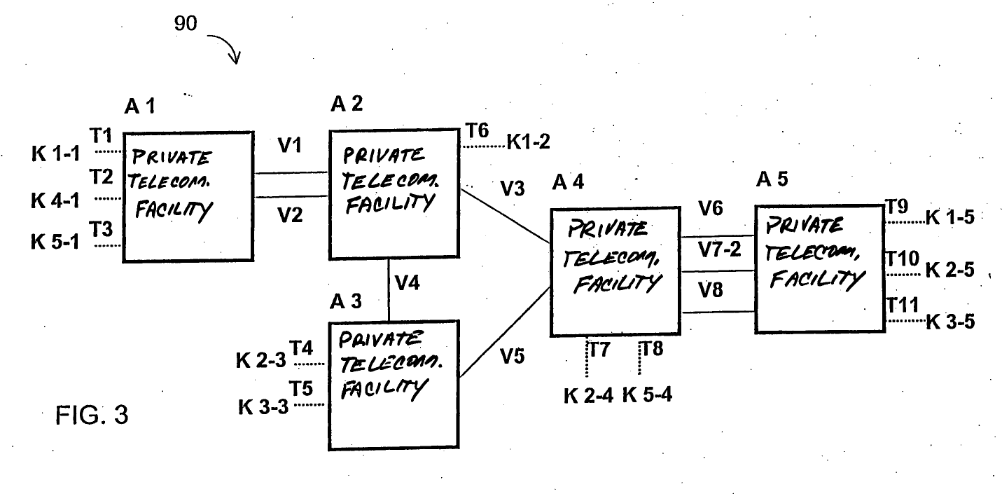

FIG. 3 shows a group 90 of customer based private telecommunications facilities A1, A2, A3, A4, A4 according to the invention.

In an overview as to the symbols used in FIG. 3, A_{y} represents the actual telecommunication facility y where y is any number representing the particular telecommunication facility; K_{x-y} represents 1 . . . n subscribers of the client x of the telecommunication facility y;
V_{z} represents the tie line z connecting the telecommunication facilities of the group where z is an integer identifying that tie line,
V_{z-x} refers to a tie line z for exclusive use by the client x, and

T_{w} represents the subscriber connection lines w where w is also an integer.

FIG. 3 shows a variety of different configurations of the telecommunication facilities within a group. For example, the telecommunication facilities A2, A3 and A4 are connected by respective single tie lines with one another, namely, the tie line V₃ between facilities A2 and A4, the tie line V4 between the facility A2 and the facility A3 and the tie line V5 between the facility A3 and the facility A4.

The telecommunication facilities A1 and A2 are connected by two tie lines V1 and V2 while the facilities A4 and A5 are connected by 3 tie lines V6, V7-2 (exclusive to client 2) and V8. The telecommunication facilities A2, A3 and A4 are in a ring structure while the facilities connected to the ring structure are in cascade.

To the facility A2 only one client, namely the client K1, is connected, this client also being represented in the other telecommunication facilities A1 and A5. One client K4 is characterized by the fact that its terminal devices are connected only to one telecommunication facility, namely, A1. However, can telecommunication facility A1 has terminal devices of other clients K1, K5 connected thereto. These clients, however, have their terminal devices distributed in the group such that, for example, the client K1 is represented in facilities A1, A2 and A5 whereas client K5 is represented in facilities A1 and A4.

Several clients, namely, K1, K2, K3, K5 are characterized by the fact that there terminal devices are connected to pluralities of the facilities of the group. The tie lines V1 through V6 and V8 can be used for multiple clients whereas one tie line V7-2 is provided for the exclusive use by one client, namely, the client K2. The system or group has transit nodes, for example, facility A4 for the connection of terminal devices K1-5 and K1-2 of the client K1 and to which no terminal device of client K1 is connected. The facility A4 is also a transit node for the connections K2-5 and K2-3 and at the same time has a terminal device of client 2 connected thereto, namely, K2-4. To avoid obstructing the drawing the connection of trunk lines or lines to the public exchange from one or more of the facilities of the group have been omitted although it will be understood that one or more facilities may have such lines.

The customer based telecommunications group 90 thus has tie lines between the customer based telecommunication facilities, trunk lines to other facilities and systems where trunk lines to an exchange or central office of a public network.

The telecommunications facilities A1, A2, A3, A4, A5 each have a database system serving as a repository of data which enables the facility. The database system stores the dispatcher data for determining the facility identifying AID in which a calling and called terminal device may be connected and for enabling connection between the calling and call device through the system.

In addition, the telecommunication facility A1, A2, A3, A4 or A5 can have a respective client to client routing table for controlling traffic extending beyond the client.

According to the invention, for connections in the communications facility group, the client association of the caller and called party are determined from the call numbers determined in the group. Thus, the telecommunication facility group can distinguish between client-internal and client-external traffic. This distinction is also possible for the transit facility used for connection between terminal devices of a client which may have no terminal device connected directly to the transit facility.

Since each telecommunication facility in the group according to the invention has connections which can be assigned to a client, client specific billing at the tie lines is possible. Advantageously, such fee information can be contained in the client accessible repository or memory of the telecommunications facility so that external fee processing programs which are customer based can be avoided.

Tie lines of the system are usually used by the respective clients in common. However, they can also be so assigned that they will be exclusive for use by a single client, for example to provide for this client a certain capacity guarantee in service. The clients specific configuration is effected through the client identification number KID and the repository in the dispatcher of the requisite data for KID determination in each telecommunication facility. The KID must be singular at least in the respective telecommunication facilities. For the described method, group wide significance of the KID is not compulsory. It is, however, advantageous administratively

An enlargement of the signaling protocol by a KID is not required since the KID can be determined from the E.164 call number.

Telecommunication facilities which will not support the process can also be integrated in the group and in this case the functionality described will be practiced only in those telecommunication facilities of the group which have been designed in accordance with the invention. Thus, it is possible to use facilities which do not support the process of the invention for the connection of terminal devices to only a single client while other terminal devices with greater functionality can be connected to those clients and facilities in accordance with the invention.

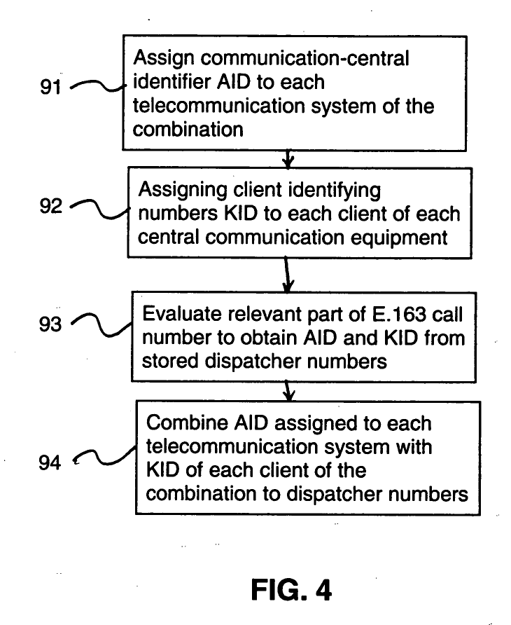

FIGS. 4 through 7 describe the method steps of the invention which indicate how the connections are made in a multi corporate network, for example, of a multiplicity of telecommunication facilities forming a group.

A number of terms are described below:

Ongoing allocation of a tie line: a connection leaves a telecommunication facility of the group via a tie line.

Arriving allocation of a tie line: a connection encounters a telecommunication facility of the group via a tie line.

Ongoing allocation of a trunk line: a connection leaves a telecommunication facility of the group via a trunk line to the public network.

Arriving allocation of a trunk line: a connection encounters a telecommunication facility of the group of a trunk line.

Connection with external source: a terminal device of the caller is connected to the public network. The connection reaches the group via a trunk line of one of the telecommunication facilities of the group.

Connection with internal source: a terminal device of the caller is directly connected to a telecommunication facility of the group.

Connection with external target: a terminal device of the called party is connected in the public network. The connection leaves the group via a trunk line of one of the telecommunication facilities of the group.

Connection with internal target: a terminal device of the called party is directly connected to a telecommunication facility of the group.

Call number plan RNP: an RNP allows the conversion of the call number of a terminal device into the hardware address of its connecting line. Within a telecommunication facility of the group for each client which has terminal devices connected to a telecommunication facility, a client-individual RNP is provided.

Transit telecommunication facility: this designation depends upon the interconnections and means that in this telecommunication facility there is neither an origin nor target of the connection. This telecommunication facility serves to provide a connection between one tie line to the next tie line of a path from the origin of the connection to its target. A transit telecommunication facility is synonymous with a pass through facility.

FIG. 4 is an information flow diagram of a method of configuring a group of private telecommunication facilities which are connected with one another by tie lines according to the invention and whereby a multiplicity of clients each with a multiplicity of terminal devices can use the group independently of one another. In a group according to the invention, at least one of the telephone facilities is provided such that the method of the invention can be carried out therein. The group according to the invention can have other facilities in which the process of the invention can be carried out as well as facilities in which the process of the invention need not be carried out.

In one of the facilities of the group, in process step 91 each facility of the group is assigned a facility identification number AID for identifying that facility in the group. In the same facility in step 92, each client is assigned a client identification number KID. In one facility to which a terminal device is connected, a client-individual call number plan for each client defines the connections to the terminal devices in this telecommunication facility.

In step 93, the evaluation-relevant parts of E.164 call numbers are stored to form an AID and KID based upon dispatcher numbers for subscribers of the further facility. Facilities also are possible to which no terminal device is connected and which only serve to connect other facilities with one another. A telephone facility according to the invention can be configured also only as a connection between other facilities. This, however, is a special case. In step 94 in the same facility, an assignment is made of the facility identification number AID for all facilities of the group and the client identification numbers KID of al clients of the group to produce the respective dispatcher numbers. Steps 91 through 94 prepare the facility for networking in the group. Preferably all connected terminal devices are embraced. The term group, as used here and in the sense of the invention, thus encompasses all facilities whose AID can be determined in the course of the method of the invention and will define a certain facility of the group. It is also possible for several of the facilities to form a subgroup which can be connected via a connecting facility to the group and whereby the connecting facility in the group represents the entire subgroup. This means that within the group all terminal devices of the subgroup are assigned to the connecting facility. The entire communication between group and subgroup thus takes place via the connecting group which assumes the role of control facility for the subgroup.

The connection of a subgroup through a single facility is possible because the facilities in which the method according to the invention is carried out are independent of one another so that such facility can process an incoming call based upon its own data, namely, intrinsically stored AID, KID and dispatcher numbers. The AID and KID can be specifically given in each connecting facility. Advantageously, for the group selection, however, a group wide single output provides the AID as well as the KID.

In a preferred feature of the invention, in a process step 95, not shown in FIG. 4, a client to client routing table is produced which, for each client identification number KID defines whether group-internal traffic is permitted. This is carried out advantageously in each facility of the group. Thus each facility can determine the traffic process for client-internal and client-external traffic. Preferably the client identification number KID in the group is consistent, uniformly or standardized.

In another preferred feature of the invention in a method step 96 (not seen in FIG. 4), in each facility of the group there is an assignment to that facility of the group via the facility identification AID, a respective tie line which can be reached through this tie line.

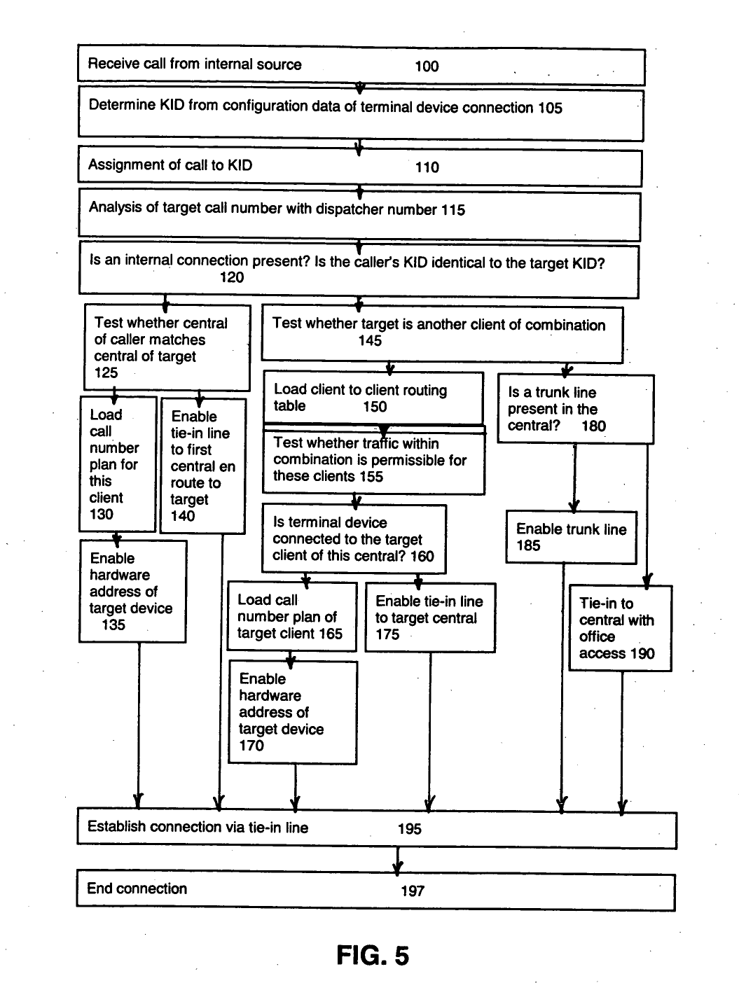

In FIGS. 5 to 7, the method steps in a telecommunication facility are shown separately for the facility which may originate the connection and the telecommunication facility with the target of the connection. Origin and target of a connection can directly involve terminal devices to be connected together through the telecommunication facilities of the group or through trunk lines to a public network.

FIG. 5 shows a flow diagram of a method of operating a group of private facilities according to the invention upon receipt of a call from an internal source.

In step 100, a call from an internal source is received. In step 105 from the configuration data of the terminal device the respective KID is determined. The AID of the same device will be the same for all connected terminal devices and is stored once in the central data structure of the facility. This is effected usually through the hardware address of the terminal device connection as the starting data. The KID can alternatively be determined through the dispatcher number of the terminal device. In step 110 the assignment of the call to the KID detected in step 105 is carried out.

In step 150, the target call number is analyzed with the dispatcher numbers. When the target is found to lie within the group, i.e. a part of the target call number agrees with a dispatcher number, the KID and the AID of the target are determined from stored data since they are associated with the dispatcher number.

In step 120, a question is posed whether a client-internal connection is present and whether the KID of the caller is identical to the KID of the target. In the affirmative, a branching to step 125 is effective in which a test is made as to whether the telecommunication facility of the caller and called party are identical and whether called and calling terminal devices are connected to the same facility. Should this be the case, the branching to step 130 takes place in which the call number plan for this client is loaded. With the call number plan in step 195, the connection is made. The connection is terminated in step 197.

In case the telecommunication facility of the caller and the target are not identical, the branching from step 125 to step 140 takes place and the tie line to the first facility becomes part of the enabled path. Then with this tie line the connection is made in step 195 and again in step 197.

If there is no client-internal connection present and the KID of the caller is not identical to the KID of the target, step 120 is branched to step 145 in which a test is made as to whether the target is known to another client of the group, i.e. whether the KID of the target lies in the group. If the answer is in the affirmative branching to step 150 occurs and the client to client routing table is loaded. With the client to client routing table in step 55 a test is made as to whether a group-internal traffic between terminal groups of these clients is permissible. In the affirmative, branching is effected to step 160. In the latter, a test is made as to whether the terminal device of the target client is connected to this facility. In the affirmative, the signal is branched to step 165 and the call number plan of the target client is loaded. Then the hardware address of the target device is determined in step 170.

Thereafter, again in step 195, the connection is made and terminated in step 197. If the terminal device of the target client is not connected to the same telecommunications facility, step 160 is branched to step 175 in which the tie line to the target facility is determined. Again, the connection is made and terminated in steps 195 and 197.

In case the group-internal traffic between terminal devices of this client is not permitted, step 155 branches to step 180 and a determination is made as to whether a trunk line is available in the respective telecommunication facility. If it is, the trunk line is determined in step 185 and the connection made and terminated in steps 195 and 197.

If no trunk line is available in the respective telecommunication facility, step 180 is branched to step 190 and the tie line to the telecommunication facility with a trunk line is enabled. Again, the connection is made and terminated in steps 195 and 197.

If the target is not known in the group, step 145 is branched directly to step 180 in which the procedures described above are followed.

FIG. 5 thus shows the flow of operations in the telecommunication facility of a terminal device that initiates a connection when the interaction between the terminal devices of the same client are internal to the group and connections which the virtual telecommunications facilities of the client permit depending on the configuration via client to client routing tables and over the public net. Steps 145, 150, 155, 180 serve where the public net is used whereas process steps 145, 150, 155, 160, 165, 170 and 175 serve for group internal operations. Steps 180, 185 and 190 take into consideration that in the group of facilities according to the invention, not all facilities may have trunk lines or trunk access. So in step 190 a tie line is provided which can be connected directly or through another telecommunication facility of the group to a facility with trunk access. By enabling the tie line, steps 140, 175 and 190 can be used to establish exclusive conversation between terminal devices of such clients. If the connecting line for an exclusive conversation is not available, connecting lines having collective or multiple client use will be selected.

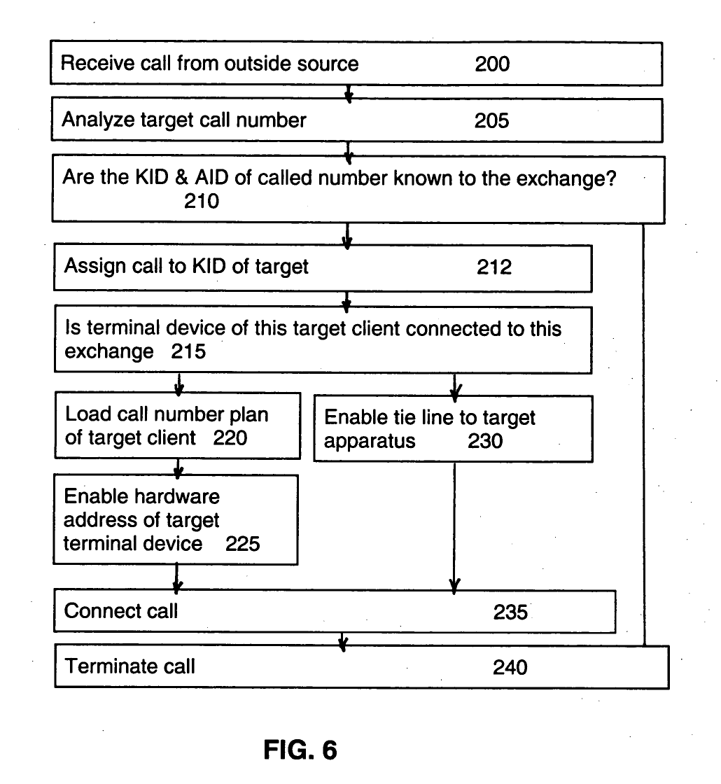

FIG. 6 shows the flow diagram of a process for operating the group when a call is received from an external source. In step 20 a call is received from the external source. In step 205, the target call number is analyzed. From a target within the group the KID and AID of the target are determined through the stored dispatcher numbers. Where a part of the target call number agrees with a dispatcher number, the KID and the AID of the target are obtained from the store data is associated with the dispatcher number.

In step 210 a determination is made as to whether the KID and AID of the called terminal disclaimer is known in the group. In the affirmative branching to step 212 is effected in which the KID of the target is assigned to the call. In step 215 a test is made as to whether the terminal device of the target client is connected to the particular facility. If this is the case, branching to step 220 occurs and the call number plan of the target client is loaded. Then the hardware address of the target device is obtained in step 225 and the connection made in step 235 and terminated in step 240. If the terminal device of the target client is not connected to the same telecommunication facility, step 215 branches to step 230 in which the tie line to the target facility is enabled. Then the connection is again made and terminated in steps 235 and 240. If in step 210 the KID and the AID of the calling terminal device are not known in the group, branching to 240 terminates the call.

FIG. 6 thus shows a flow in the facility connected to a trunk line over which a connection with an external source may be made with the group. In steps 215 and 230 it is recognized that in the group not all of the facilities may have trunk access. In step 230 a tie line can be connected to a target device through another facility. By enabling the tie line in step 230, an exclusive connection can be made for the particular client. If the connection for exclusive communication is not available, the connection can be made over a common tie line.

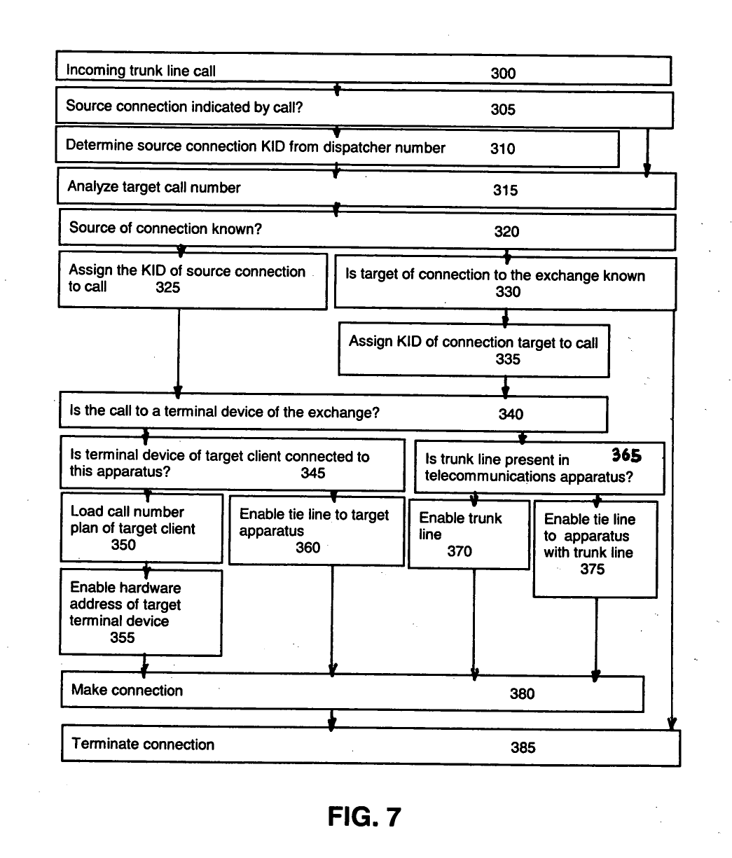

FIG. 7 shows a flow diagram of a method where the call arrives on a tie line. In step 300 a call is assumed to arrive on a tie line of the group. In step 305 a determination is made as to whether the call number of the origin is contained in the signal received. If that is the case in step 310 the originating call number is analyzed and via the dispatcher number the KID of the originating device is determined. The call can originate in the group. In step 315, the dispatcher numbers are used to analyze the target call number is within the group and a part of the target call number coincides with the dispatcher number, the KID and AID of the target are determined from the store data associated with the dispatcher number. If in 305 the call number is not contained in the signal, the sequence is branched directly into step 315 to analyze the target call number. In step 320 it is determined whether the origin of the connection is known to the group. If so, it is branched to step 325 in which the KID of the origin is assigned to the call. This takes place in step 340. In step 320, if the origin is unknown to the group, branching is to step 330 in which it is determined whether the target of the connection is known to the group. If so, branch to step 335 where the kid of the target connection is assigned to the call. Then step 340 follows in which it is determined whether a call to a terminal device in the group is present, that is whether the KID of the target and the AID of the target are known. If so, branch to step 345 and test whether the terminal device of the target client is connected to this facility. If that is the case branch to step 350 and load the call number plan of the target client. Then the hardware address of the target device is determined in step 355, the call is connected at step 380 and the call is terminated in step 385.

If the terminal device of the target client is not connected to the same telecommunication facility step 345 is branched to step 360 in which a tie line to the target facility is enabled. Then the connection is made and terminated in steps 380 and 385. In case in step 340 no call to a terminal device in the group is present, step 340 branches to step 365 and a determination is made as to whether a trunk line is present in the respective facility. If so, the trunk line is enabled in step 370 and the connection made and ended in steps 380 and 385.

If step 365 shows no trunk line to be present in the facility, it branches to step 375 and a tie line to a facility with a trunk line is enabled and again the connection made and ended in steps 380 and 385.

If the target is not known to the group step 330 branches directly to step 385 in which the connection terminates.

FIG. 7 then provides a sequence in a telecommunication facility where the call arrives on a dedicated tie line. This facility can be the final facility for the connection, i.e. the terminal device of the target subscriber can be directly connected to this facility. It can be a transfer unit for this connection at the public net. It can be a pass through facility for this connection, that is a further tie line can be provided in this facility over which the connection is made. It also can be a facility which can interrupt that communication or prevent that connection from being made when both the target and the source are external.

Step 365 demonstrates that in the group of the invention not all of the facilities may be equipped with trunk access and thus in step 375 a tie line can be connected directly or via a further facility of the group to a facility with trunk access. The tie lines are enabled in steps 360 and 375 for an exclusive connection of the particular client, or if an exclusive connection is not available, a tie line for collective use can be employed. A connection of the arriving occupied line utilizes the KID associated with the call origin and steps 305, 310, 315, 320, 325, possibly with application of appropriate tariffs. If that is not possible, the connection of the KID of the target is assigned and steps 320, 330 and 335 are used. Connections which have neither KID assigned thereto follow steps 330, 385. The invention utilizes a dispatcher software which serves to identify a client and a facility in a group of such facilities based upon the client identification number KID and the facility identification number AID. The dispatcher utilizes dispatcher numbers which are parts of the E.164 call number and are stored in a further facility with subscribers connected thereto based upon the call number of an incoming call. The invention is not limited to the described example and the aspects set forth above but only by the scope of the claims and permits equivalents within the scope thereof.

1. A telecommunications facility for forming a group with at least one other said telecommunications facility and comprising a memory for storing data as to subscribers of clients of said at least one other telecommunications facility capable of utilizing said group of telecommunications facilities together and independently from one another, said data including evaluation-relevant parts of call numbers of each subscriber of said at least one other telecommunications facility capable of utilizing said group of telecommunications facilities together and independently from one another, a facility identification number AID of said at least one other call number is connected, and a client identification number KID of the client of the respective subscriber.

2. The telecommunications facility to which the respective subscriber with the respective facility according to claim 1, further comprising a dispatcher unit for determining a KID and an AID or for determining an AID from a call number of an incoming call.

3. A group of at least two telecommunications facilities interconnected for call transfer between them, at least one of said telephone facilities being as defined in claim 2, said facilities being interconnected for call transfer to subscribers and clients thereof.

4. The group of telecommunications facilities defined in claim 3 wherein at least one of said telecommunications facilities has a client-to-client routing table which, for each client identification number KID permits internal traffic within the group for subscribers assigned to the corresponding client.

5. A method of configuring a group of interconnected telecommunications facilities each having a plurality of clients each with a respective plurality of terminal devices capable of communicating through the group independently of one another, said method comprising the steps, in at least one of said telecommunications facilities, of:
assigning a respective facility identification number AID to each of said facilities in said group;
assigning a client identification number KID to each client in the group;
storing evaluation-relevant parts of E.164 call numbers of subscribers of said one of said facilities and subscribers of other facilities which are required for determination of the AID and KID thereof as dispatcher numbers; and
assigning the AID and KID to the dispatcher numbers.

6. The method defined in claim 5, further comprising the step of creating a client-to-client routing table which, for each client identification number KID permits internal traffic within the group for subscribers assigned to the corresponding client.

7. The method defined in claim 5, further comprising the step, in each of said facilities, of assigning each of said facilities by the respective facility identification number AID to a tie line over which the respective facility can be reached.

8. The method defined in claim 7, further comprising the step of reserving a transmission capacity over a tie line from one facility to another facility of the group for a client based upon the client identification number KID thereof.

9. The method defined in claim 5 wherein both KID and AID are determined for both caller and called for traffic external to a client and the group.

10. The method defined in claim 5 wherein at least one of the further facilities is a conventional extension exchange facility with subscribers of a single client.

11. A method of operating a group of telecommunications facilities which are interconnected by tie lines and which have multiple clients each of which can have a plurality of terminal devices which can use the group independently from one another, said method comprising the steps of:
receiving a call;
determining a client identification number KID singularly assigned to each client from a call number of the call; and
assigning the call to the client identified by the determined client identification number KID.

12. The method defined in claim 11, further comprising the step of determining whether the call derives from a caller belonging to the same client as the called terminal device denominated by said call number.

13. The method defined in claim 11, further comprising the step of determining whether a connection is possible internally of the group between a caller originating the call a called party denominated by said call number.

14. The method defined in claim 11, further comprising the step of deriving a sender KID from an E.164 call number of a sender originating said call or an evaluation-relevant part thereof and a target KID from an E.164 call number of a called party or an evaluation-relevant part thereof.

15. The method defined in claim 11, further comprising the step of determining a facility identification number AID for the facility of the terminal device denominated by said call number from said call number.

16. The method defined in claim 15, further comprising the step of testing whether the AID of the facility denominated by said call number is identical to the AID of a testing facility.

17. The method defined in claim 14 wherein the determination of the KID is effected with dispatcher numbers stored in one of said telecommunication facilities in the form of parts of E.164 call numbers of subscribers of said one of said facilities and which are required for determination of AID and KID from the respective call number.

18. The method defined in claim 14, further comprising charging for traffic internal to the group and external to a client at a tariff individual to the respective client.

19. The method defined in claim 14, further comprising charging for traffic internal to the group and internal to a client at a tariff individual to the respective client.

20. Dispatcher software for identifying a client and a telecommunications facility in a group of telecommunication facilities interconnected by tie lines and based upon a client identification number KID assigned to each of a multiplicity of clients of each telecommunication facility of the group and a telecommunications facility identification number AID assigned to each telecommunications facility of the group, whereby the identification of the client and facility is effected with the aid of dispatch number stored in a dispatcher of one of the telecommunications facilities in a form of parts of E.164 call numbers of associate terminal devices of the group to give an AID and KID from a called number of a terminal device upon receipt of a call.
